(19) United States
(12) Patent Application Publication
(10) Pub. No.: US 2007/0263146 A1
(43) Pub. Date: Nov. 15, 2007

(54) OCB mode transflective liquid crystal display device

(75) Inventors: I-An Yao, Miao-Li (TW); Hung-Lin Ko, Miao-Li (TW); Chiu-Lien Yang, Miao-Li (TW); Chuen-Ju Chen, Miao-Li (TW); Jin-Jei Wu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/803,256

(22) Filed: May 14, 2007

(30) Foreign Application Priority Data
May 12, 2006 (TW) 95116846

(51) Int. Cl. G02F 1/1335

(52) U.S. Cl. 349/114

(57) ABSTRACT

An exemplary liquid crystal display device (2) includes: a first substrate (21) and a second substrate (22); a liquid crystal layer (23) having liquid crystal molecules located between the first and second substrates, the liquid crystal molecules are intermingled with chiral dopant, and are in a twist π cell state before the liquid crystal display device is turned on; and a plurality of pixel regions. Each of the pixel regions defines a reflection region and a transmission region, whereby a thickness of the liquid crystal layer in the reflection region is less than a thickness of the liquid crystal layer in the transmission region.

### FIELD OF THE INVENTION

The present invention relates to liquid crystal display (LCD) devices that operate in OCB (optically compensated bend) mode, and more particularly to a reflection/transmission type LCD device capable of providing a display both in a reflection mode and a transmission mode.

### GENERAL BACKGROUND

Among LCD products, there have been the following three types of LCD devices commercially available: a reflection type LCD device utilizing ambient light, a transmission type LCD device utilizing backlight, and a semi-transmission type LCD device equipped with a half mirror and a backlight.

With a reflection type LCD device, a display becomes less visible in a poorly lit environment. In contrast, a display of a transmission type LCD device appears hazy in strong ambient light (e.g., outdoor sunlight). Thus researchers sought to provide an LCD device capable of functioning in both modes so as to yield a satisfactory display in any environment. In due course, a semi-transmission type LCD device was disclosed in Japanese Laid-Open Publication No. 7-333598.

However, the above-mentioned semi-transmission type LCD device typically has the following problems.

The semi-transmission type LCD device uses a half mirror instead of the reflective plate used in a reflection type LCD device, and has a minute transmission region (e.g., minute holes in a thin metal film) in a reflection region, thereby providing a display by utilizing transmitted light as well as reflected light. Since both the reflected light and the transmitted light used for the display pass through the same liquid crystal layer of the LCD device, an optical path of the reflected light is twice as long as that of the transmitted light. This causes a large difference in the retardation of the liquid crystal layer with respect to the reflected light and the transmitted light. Thus in general, a satisfactory display image cannot be obtained. Furthermore, the means for providing both a reflection mode and a transmission mode for the display are superimposed on each other, so that the respective modes cannot be separately optimized. This result in difficulty in providing a quality color display image, and tends to cause a blurred display image as well.

What is needed, therefore, is a liquid crystal display device that overcomes the above-described deficiencies.

### SUMMARY

An exemplary liquid crystal display device includes: a first substrate and a second substrate; a liquid crystal layer having liquid crystal molecules located between the first and second substrates, the liquid crystal molecules are intermingled with chiral dopant, and are in a twist π cell state before the liquid crystal display device is turned on; and a plurality of pixel regions. Each of the pixel regions defines a reflection region and a transmission region, whereby a thickness of the liquid crystal layer in the reflection region is less than a thickness of the liquid crystal layer in the transmission region.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is a side, cross-sectional view of part of an OCB mode transflective type LCD device according to a first embodiment of the present invention.

FIG. 2 is a diagram corresponding to part of the LCD device of FIG. 1, showing a transition process of converting liquid crystal molecules of the LCD device from a twist π cell state into a bend alignment state.

FIG. 3 is a side, cross-sectional view of part of an LCD device according to a second embodiment of the present invention.

### DETAILED DESCRIPTION OF PREFERRED EMBODIMENTS

Referring to FIG. 1, a side, cross-sectional view of part of an OCB mode transflective type LCD device 2 according to a first embodiment of the present invention is shown. The LCD device 2 includes a first substrate 21, a second substrate 22 disposed parallel to and spaced apart from the first substrate 21, and a liquid crystal layer 23 having liquid crystal molecules (not labeled) between the substrates 21 and 22. The liquid crystal molecules are bend aligned so that the LCD device 2 can operate in an optically compensated bend (OCB) mode.

A first optical compensation film 214, a first retardation film 213, and a first polarizer 212 are disposed in that order on an outer surface of the first substrate 22. A second optical compensation film 224, a second retardation film 223, and a second polarizer 222 are disposed in that order on an outer surface of the second substrate 22. The first and second retardation films 213, 223 may be wide-band quarter-wave plates, which are biaxial retardation films.

A color filter 215, a transparent common electrode 216, and a first alignment film 218 are disposed in that order on an inner surface of the first substrate 21. The common electrode 216 is made of a transparent conductive material such as indium-tin-oxide (ITO) or indium-zinc-oxide (IZO).

A passivation layer 229 is formed on an inner surface of the second substrate 22. The passivation layer 229 forms a plurality of separate protrusions (not labeled). A plurality of separate transmission electrodes 226 is formed on the inner surface of the second substrate 22. The protrusions of the passivation layer 229 and the transmission electrodes 226 are alternately disposed on the inner surface of the second substrate 22. A plurality of reflection electrodes 227 is formed on inner surfaces of the protrusions of the passivation layer 229. A second alignment film 228 covers the reflection electrodes 227 and the transmission electrodes 226. In accordance with an exemplary embodiment of the present invention, the transmission electrodes 226 are made of a transparent conductive material such as indium-tin-oxide (ITO) or indium-zinc-oxide (IZO), and the reflection electrodes 227 are made of metal with a high reflective ratio such as aluminum (Al).

The liquid crystal layer 23, the common electrode 216, the transmission electrodes 226, and the reflection electrodes 227 cooperatively define a plurality of pixel regions (not labeled). Each pixel region includes a reflection region corresponding to a respective reflection electrode 227, and a transmission region corresponding to a respective transmission electrode 226. A thickness of the liquid crystal layer 23 in the transmission regions is greater than that of the liquid crystal layer 23 in the reflection regions.

The first polarizer 212 has an absorption axis parallel to a rubbing direction of the first alignment film 218, and the second polarizer 222 has an absorption axis perpendicular to that of the first polarizer 212. A slow axis of the first retardation film 213 maintains an angle of 45° relative to the absorption axis of the first polarizer 212. A slow axis of the second retardation film 223 maintains an angle perpendicular to the slow axis of the first retardation film 213.

The first and second alignment films 218, 228 are each homogeneously aligned alignment films. The alignments of the first and second alignment films 218, 228 are parallel to each other. A pre-tilt angle of the liquid crystal molecules adjacent to the substrates 21 and 22 is in a range from 0° to 15°. The liquid crystal molecules may be positive uniaxial liquid crystal material that is intermingled with chiral dopant. Typically, a ratio d/p=0˜1, wherein d represents a thickness of the liquid crystal layer 23 in the transmission regions, and p represents a pitch of the chiral dopant. The chiral dopant helps the liquid crystal molecules to orient in a twist pattern relative to a plane parallel to the first and second substrates 21, 22. Thereby, from the first alignment film 218 to the second alignment film 228, the liquid crystal molecules are oriented such that they progressively twist through an angle of 180°. Thus, the liquid crystal molecules are in a so-called twist π cell state.

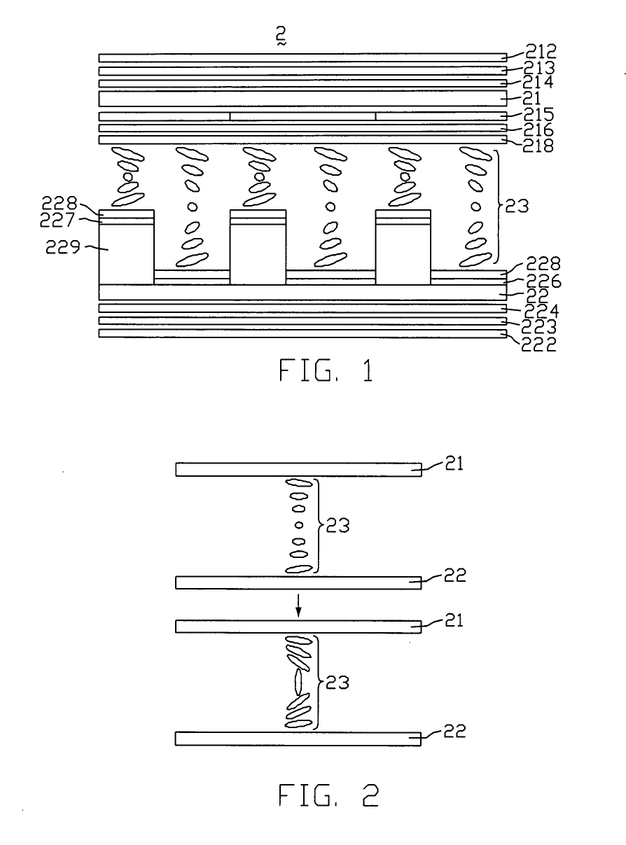

Also referring to FIG. 2, before turning on the LCD device 2, the liquid crystal molecules of the liquid crystal layer 23 are in the twist π cell state. When the LCD device 2 is turned on and before a regular display can be commenced, it is necessary to uniformly convert all the liquid crystal molecules from the twist π cell state into a bend alignment state. This initial transition process is described in detail below. After the initial transition process is completed, a voltage is applied to the LCD device 2, and accordingly an electric field is generated between the common electrode 218 and the transmission and reflection electrodes 226, 227. The electric field can control the orientations of the liquid crystal molecules in order that the LCD device 2 displays images.

With the above-described configuration, the LCD device 2 is capable of providing a display both in a reflection mode and a transmission mode.

During the transition process of converting the liquid crystal molecules from the twist π cell state into the bend alignment state, the liquid crystal molecules in the twist π cell state can rapidly twist when a voltage is applied thereto. That is, for the transition process, the liquid crystal molecules in the initial twist π cell state have a fast response time. Moreover, the liquid crystal molecules in the LCD device 2 are bend-aligned to have a pre-tilt angle. This helps ensure the liquid crystal molecules can more easily adjust their orientations when a voltage is applied to the LCD device 2 and a change in a driving electric field is effected. Thereby, the LCD device 2 has a fast response time.

Various modifications and alterations of the above-described embodiments are possible. For example, a thickness of the liquid crystal layer 23 in the transmission regions may be equal to that of the liquid crystal layer 23 in the reflection regions. Each of the retardation films 213, 223 may selectively instead be a single compensation film, an A-plate compensation film, or a discotic molecular film. The LCD device 2 may employ only a single optical compensation film 214/224 disposed on either the first substrate 21 or on the second substrate 22. Furthermore, any one, more, or all of the retardation films 213, 223 and/or the optical compensation films 214, 224 may be selectively disposed on or at the inner surface of either or both of the first and second substrates 21, 22.

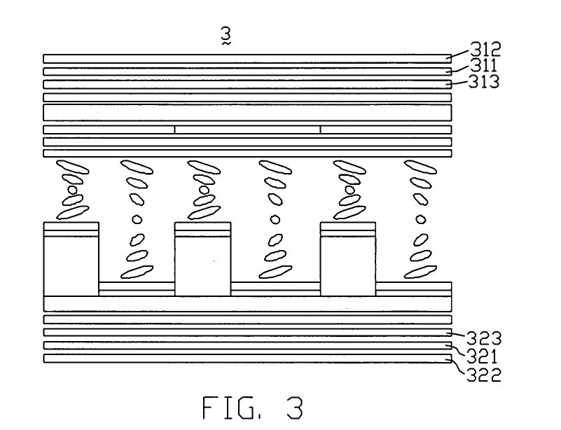

FIG. 3 is a side, cross-sectional view of part of an OCB mode transflective type LCD device 3 according to a second embodiment of the present invention. The LCD device 3 is similar to the LCD device 2. However, the LCD device 3 includes a third retardation film 311 disposed between a first retardation film 313 and a first polarizer 312, and a fourth retardation film 321 disposed between a second retardation film 323 and a second polarizer 322. The first and second retardation films 313, 323 are quarter-wave plates, and the third and fourth retardation films 311, 321 are half-wave plates.

An absorption axis of the first polarizer 312 maintains an angle in the range from 10° to 20° relative to a slow axis of the third retardation film 311, and an absorption axis of the second polarizer 322 maintains an angle in the range from 10° to 20° relative to a slow axis of the fourth retardation film 321. The slow axis of the third retardation film 311 maintains an angle in the range from 55° to 65° relative to a slow axis of the first retardation film 313, and the slow axis of the fourth retardation film 321 maintains an angle in the range from 55° to 65° relative to a slow axis of the second retardation film 323.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display device, comprising:
a first substrate and a second substrate;
a liquid crystal layer having liquid crystal molecules located between the first and second substrates, the liquid crystal molecules being intermingled with chiral dopant, and being in a twist π cell state before the liquid crystal display device is turned on; and
a plurality of pixel regions, each of the pixel regions defining a reflection region and a transmission region.

2. The liquid crystal display device as claimed in claim 1, wherein when the liquid crystal display device is turned on, the liquid crystal molecules are converted from the twist π cell state into a bend alignment state so that the liquid crystal display device is able to operate in an optically compensated bend (OCB) mode.

3. The liquid crystal display device as claimed in claim 1, wherein a ration d/p=0˜1, wherein d represents a thickness of the liquid crystal layer in the transmission regions, and p represents a pitch of the chiral dopant.

4. The liquid crystal display device as claimed in claim 1, wherein a thickness of the liquid crystal layer in the reflection regions is less than a thickness of the liquid crystal layer in the transmission regions.

5. The liquid crystal display device as claimed in claim 1, wherein a thickness of the liquid crystal layer in the reflection regions is equal to a thickness of the liquid crystal layer in the transmission regions.

6. The liquid crystal display device as claimed in claim 1, further comprising a first alignment film disposed between the first substrate and the liquid crystal layer, and a second alignment film disposed between the second substrate and the liquid crystal layer, wherein each of the first and second alignment films is a homogeneous aligned alignment film, and the alignments of the first and second alignment films are parallel to each other, and a pre-tilt angle of the liquid crystal molecules adjacent to the first and second substrates is in the range of 0° to 15°.

7. The liquid crystal display device as claimed in claim 6, wherein the liquid crystal molecules are positive uniaxial liquid crystal material.

8. The liquid crystal display device as claimed in claim 6, further comprising a first polarizer disposed at an outer surface of the first substrate and a second polarizer disposed at an outer surface of the second substrate, wherein the first polarizer has an absorption axis perpendicular to an absorption axis of the second polarizer.

9. The liquid crystal display device as claimed in claim 8, wherein the absorption axis of the first polarizer is parallel to a rubbing direction of the first alignment film.

10. The liquid crystal display device as claimed in claim 9, further comprising a first retardation film disposed between the first polarizer and the first substrate, and a second retardation film disposed between the second polarizer and the second substrate.

11. The liquid crystal display device as claimed in claim 10, wherein a slow axis of the first retardation film maintains an angle of 45° relative to the absorption axis of the first polarizer, and a slow axis of the second retardation film maintains an angle perpendicular to the slow axis of the first retardation film.

12. The liquid crystal display device as claimed in claim 11, wherein the first and second retardation films are wide-band quarter-wave plates.

13. The liquid crystal display device as claimed in claim 11, wherein the first and second retardation films are single compensation films.

14. The liquid crystal display device as claimed in claim 11, wherein the first and second retardation films are A-plate compensation films.

15. The liquid crystal display device as claimed in claim 11, wherein the first and second retardation films are discotic molecular films.

16. The liquid crystal display device as claimed in claim 10, further comprising a third retardation film disposed between the first retardation film and the first polarizer, and a fourth retardation film disposed between the second retardation film and the second polarizer.

17. The liquid crystal display device as claimed in claim 16, wherein the third and fourth retardation films are half-wave plates.

18. The liquid crystal display device as claimed in claim 17, wherein an absorption axis of the first polarizer maintains an angle in the range from 10° to 20° relative to a slow axis of the third retardation film, and an absorption axis of the second polarizer maintains an angle in the range from 10° to 20° relative to a slow axis of the fourth retardation film.

19. The liquid crystal display device as claimed in claim 18, wherein the slow axis of the third retardation film maintains an angle in the range from 55° to 65° relative to a slow axis of the first retardation film, and the slow axis of the fourth retardation film maintains an angle in the range from 55° to 65° relative to a slow axis of the second retardation film.

20. A liquid crystal display comprising:
a first substrate and a second substrate;
a liquid crystal layer having liquid crystal molecules located between the first and second substrates, the liquid crystal molecules being in a twist π cell state before the liquid crystal display device is turned on; and
a plurality of pixel regions, each of the pixel regions defining a reflection region and a transmission region; wherein
a height of said liquid crystal layer is variant in a staggered manner.
